(19) United States
(12) Patent Application Publication
(10) Pub. No.: US 2005/0289627 A1
(43) Pub. Date: Dec. 29, 2005

(54) Virtual community television system

(76) Inventor: Jack E. Lohman, Milwaukee, WI (US)

Correspondence Address: QUARLES & BRADY LLP, 411 E. WISCONSIN AVENUE, SUITE 2040, MILWAUKEE, WI, 53202-4497, US

(21) Appl. No.: 11/117,623

(22) Filed: Apr. 28, 2005

Related U.S. Application Data
(60) Provisional application No. 60/565,996, filed on Apr. 28, 2004.

(51) Int. Cl. H04N 7/173; G06F 13/00; H04N 5/50

(52) U.S. Cl. 725/109; 725/112; 725/38; 348/731; 725/100

(57) ABSTRACT

A television system provides a virtual audience community for television viewers by displaying a common shared broadcast and images of other viewers of the broadcast.

### CROSS-REFERENCE TO RELATED APPLICATIONS

This application claims the benefit of U.S. provisional application No. 60/565,996, hereby incorporated by reference.

### STATEMENT REGARDING FEDERALLY SPONSORED RESEARCH OR DEVELOPMENT

### BACKGROUND OF THE INVENTION

The present invention relates to television systems for use in home entertainment and the like and in particular to a television system that provides a virtual audience community for television viewers.

Millions of households have television receivers through which they may watch sporting events or other entertainment broadcasts. Especially with the advent of high definition television, the picture and sound quality of such broadcasts can rival those of sporting arenas and movie theaters. Nevertheless, the experience of watching a sporting event alone is a far cry from the experience at the sporting event surrounded by other fans.

For this reason, it is common for individuals watching a sporting event on television to watch it with friends or family at home or with other fans in a sports bar or the like.

An unexpected benefit of the Internet was the ability to create virtual communities through chat rooms and online games and the like. Nevertheless, such communities require a fair degree of familiarity with computer software and hardware and at least, at present, the ability to easily type on a keyboard.

### BRIEF SUMMARY OF THE INVENTION

The present invention provides a television receiver that simultaneously carries both a standard broadcast signal, for example, of a sporting event or the like, inset with images of at least one other viewer so as to create an informal virtual audience for a broadcast event. In a preferred embodiment, the invention takes advantage of the ability of conventional television cable to transmit both FM broadcast signals and digital Internet signals, the latter which may be used to exchange non-broadcast video and audio data of other viewers. The visual and audible presence of other viewers sharing a common viewing experience provides a sense of community, a venue for informal interaction, and increases enjoyment of the broadcast entertainment.

Specifically then, the present invention provides a virtual community television system having a display monitor and a first tuner system for receiving a broadcast video program and displaying it on the display monitor. The television system also provides a second tuner system for receiving an Internet protocol digital signal to display a video signal of a remote viewer of the broadcast video program on the monitor. A camera in the system provides a video signal of a person watching the display monitor which may be transmitted as an Internet protocol digital signal to the remote viewer.

It is thus an object of at least one embodiment of the invention to provide a sense of community when multiple people, separated from each other, share the viewing of a broadcast program or sporting event.

The first tuner may be a cable television tuner and the second tuner may be a cable modem.

Thus it is an object of at least one embodiment of the invention to provide a system that may work within existing broadcast licenses and infrastructure. The community service can be provided to existing cable subscribers without the need for a license to rebroadcast the program as would be required, for example, in a pure Internet implementation. The ability to distribute video broadcasts (to many users) and virtual community data of users discussing the broadcasts, on an address specific basis, is currently available over a single cable medium.

The first tuner is a television tuner receiving a free-space radio broadcast.

Thus it is another object of at least one embodiment of the invention to provide a system that can work with flexible sources of broadcasts and Internet connections.

The display of the video signal of the remote viewer may be an inset in the display of the broadcast video program.

Thus it is another object of at least one embodiment of the invention to provide a means for creating a community experience with pre-existing display hardware.

The first tuner includes a remote control for changing a channel of the broadcast video program independently of the reception of the Internet protocol digital signal.

It is thus another object of at least one embodiment of the invention to provide a system that provides a familiar television-type interface with the users.

The invention further includes a microphone providing an audio signal of the person watching the display monitor; and the distribution amplifier system transmits the audio signal to the remote viewer.

Thus it is another object of at least one embodiment of the invention to provide both audio and visual representation of other members of the virtual community.

The broadcast video program and the video signal of the remote user may include audio tracks and the invention may include a summer adding together the audio tracks or selecting the louder of the audio tracks.

Thus it is another object of at least one embodiment of the invention to provide for the flexible integration of the broadcast program and the virtual community data.

The invention employs a virtual community cable service having a server communicating with a subscriber network providing multiple connected terminal devices, each having display monitors and cameras providing images of viewers of the display monitors. The server is programmed to broadcast a video program to the connected terminal devices and to exchange Internet protocol signals with the connected terminal devices so as to interconnect a subset of the connected terminal devices receiving the broadcast video program to each other to exchange images of viewers of the respective monitors of the subset of connected terminal devices.

Thus it is another object of at least one embodiment of the invention to provide a system for interconnecting terminals providing virtual communities for broadcasts.

The subset may be defined by a community table cross-referencing a set of Internet addresses of users of the connected terminal devices.

Thus it is another object of at least one embodiment of the invention to provide a mechanism for flexibly generating multiple virtual communities for a given broadcast event.

The virtual community cable service may accept Internet protocol signals from connected terminal devices to populate the community table.

It is thus an object of at least one embodiment of the invention to allow users themselves to define their communities.

Each connected terminal device when receiving a broadcast provides an Internet protocol signal to the server when activated to initiate the interconnection of other connected terminal devices receiving the broadcast and associated with the connected terminal devices by the community table.

Thus it is an object of at least one embodiment of the invention to allow the communities to be determined by the particular broadcasts being viewed.

These particular objects and advantages may apply to only some embodiments falling within the claims and thus do not define the scope of the invention.

### BRIEF DESCRIPTION OF THE DRAWINGS

FIG. 1 is a simplified perspective view of a home television receiver used in the present invention and configured as part of a virtual community television system;

FIG. 2 is a block diagram of the cable modem modified to simultaneously broadcast and display broadcast cable television images and sound, and Internet broadcast video and sound to be superimposed on the television receiver;

FIG. 3 is a block diagram showing interconnection of multiple home television receivers through a cable provider also providing an Internet connection for Internet communication; and

FIG. 4 is a data table held in the computer of FIG. 2 providing a simple means of connecting to community members.

### DETAILED DESCRIPTION OF THE PREFERRED EMBODIMENT

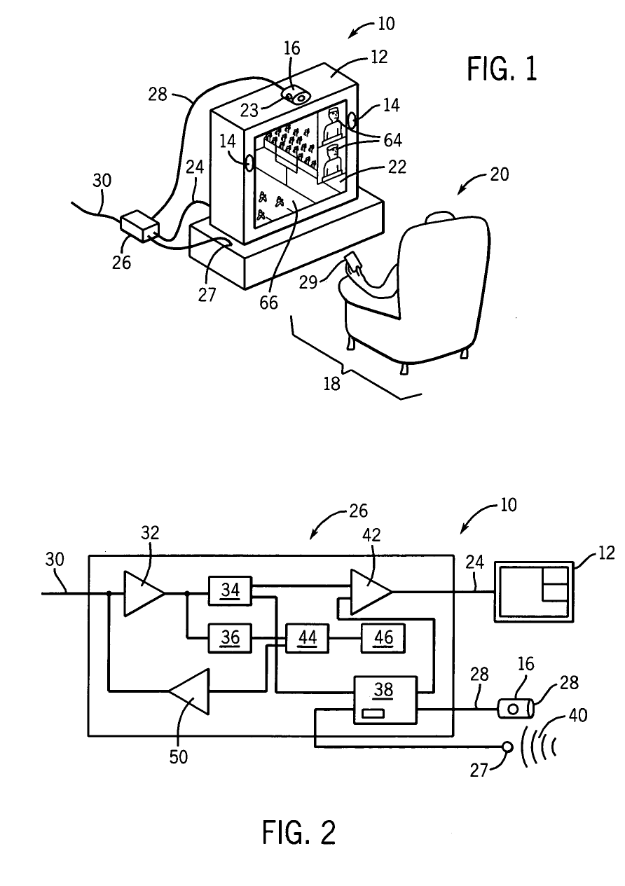

Referring now to FIG. 1, a virtual community terminal 10 may include a standard television-type display monitor 12, such as may be a cathode ray tube (CRT), a liquid crystal display (LCD), a plasma display, or other similar device.

As depicted, the display monitor 12 includes integral speakers 14 and a charge coupled device (CCD) camera 16 aimed toward a viewing area 18. A viewer 20 may sit in the viewing area 18 so as to view the display 22 of the display monitor 12 as well as hear sound from the speakers 14 and to be within the acquisition angle of the camera 16. Camera 16 may also include a built-in microphone 23 receiving sounds within the viewing area 18.

The display monitor 12 is attached via a cable 24 to a converter interface 26 as will be described in greater detail below. Converter interface 26 also receives a connection via cable 28 from the camera 16 and its microphone 23. A standard residential cable television cable 30 is also connected to the converter interface 26. The converter interface 26 may further include a remote infrared receiver 27 allowing for channel selection using a remote control 29 held by the user.

Referring now to FIG. 2, the converter interface 26 receives signals from the cable 30 at the input of a broadband amplifier 32 which boosts the signals to a standard level to be received by a first tuner 34 and second tuner 36.

The first tuner 34 is a conventional cable TV tuner and is controlled by a central processing unit (CPU) 38 receiving infrared beam 40 from the remote control 29 through remote infrared receiver 27 described before. The first tuner converts frequency multiplexed cable signals to a common frequency compatible with the input of the display monitor. The output of the first tuner 34 is received by booster amplifier 42 and provided by cable 24 to the cable input of the display monitor 12 and provides both a video and audio signal of a conventional cable program such as sporting events and movies.

The second tuner 36 provides a connection to one or more specially allocated frequency bands of the cable 30 that may be used for up linking and down linking digital data. The output of the second tuner 36 is provided to a modem 44, such a standard cable modem of conventional design, which connects to a media access controller 46. The modem also connects to a distribution amplifier 50 to provide signals to the cable 30. The media access controller 46 may receive TCP/IP protocol signals from the modem 44 and provide them to the CPU 38 and the CPU 38 may provide signals to the media access controller 46 which forwards them to the modem 44 which provides data back to a distribution amplifier 50 that provides signals on the cable 30 according to methods well known in the art. CPU 38 also receives video and audio signals over cable 28 from the camera 16 and microphone 23 for transmitting these over cable 30 using the media access controller 46 as described above.

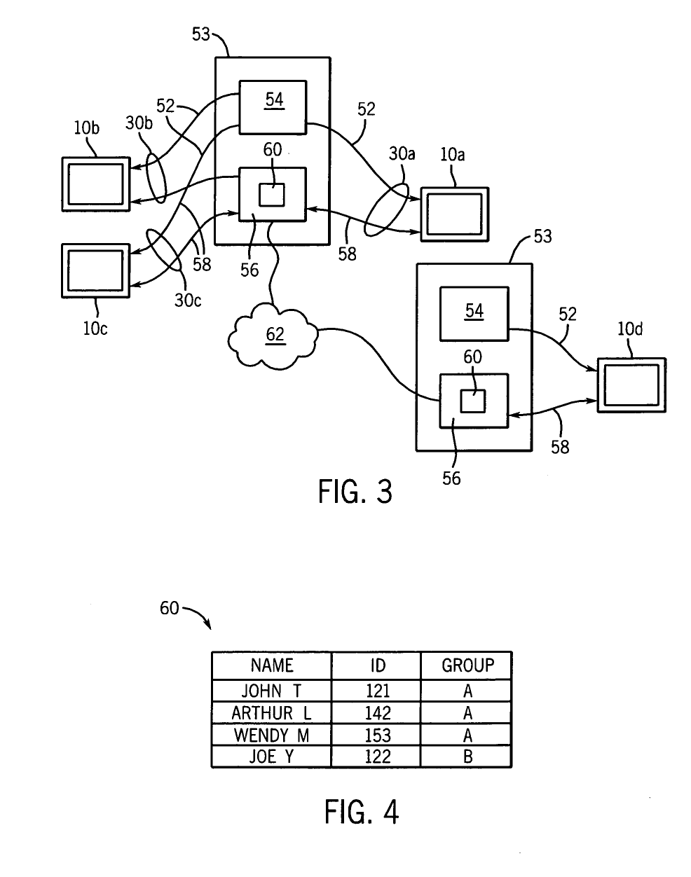

Referring now to FIG. 3, a number of virtual community terminals 10a, 10b, and 10c may be connected via the cables 30a, 30b, and 30c to receive a video stream 52 broadcast by a video server 54 from a cable company 53. The video stream 52 will be a standard FM television signal.

The cable company 53 also provides a web server 56 communicating TCP/IP or other internet protocol signals 58 over cables 30a, 30b, and 30c to the terminals 10a, 10b, and 10c, respectively. The TCP/IP signals are bi-directional.

A virtual community terminal 10d on a separate cable network, possibly from a separate cable company installation 53′, may also receive the video stream 52′ from a separate video server 54′ typically from a common network source. The virtual community terminal 10d also may exchange TCP/IP signals 58 with local web server 56′. Data may be exchanged between web servers 56 and 56′ through the Internet 62 providing a direct path between virtual community terminals 10d and any of virtual community terminals 10a-c.

Each web server 56 may be programmed to receive video and audio from cameras 16 associated with each of the terminals 10a-10d and to stream that audio and video to selected of the terminals 10a-10c contained within a database community table 60 listed held within the web server 56.

Referring to FIG. 4, the database community table 60 provides a series of names and IP address identifications for each user of a virtual community terminal 10 for the purpose of defining a community (identified and linked by a unique group identifier) to which that user belongs. Each virtual community terminal 10, upon being activated, communicates with the web servers 56 which then exchange video and audio data from the camera 16 of that virtual community terminal 10 with other virtual community terminals 10 in the same group. The exchange of video and audio data can be automatic for certain scheduled broadcasts and/or only if the broadcast is being viewed at a particular virtual community terminal 10. Further, the particular definition of the virtual community determined form the database community table 60 may vary depending on the broadcast, thus allowing one virtual community to be defined for sporting events or particular sporting events and another to be defined for a broadcast movie or the like. This is readily implemented with a broadcast class entry into the database community table 60 as will be understood to those of ordinary skill in the art.

Referring again to FIG. 1, the exchanged video and audio data from other virtual community terminals 10 is displayed as one or more inset images 64 on the main image 66, the latter showing the sporting event or other common broadcast program. In this way a viewer 20 may watch a broadcast program in the company of other viewers virtually present by the community offered by the present device. The inset images 64 thus show other viewers (and possibly the viewer 20 of the particular virtual community terminal 10) of a community watching the particular broadcast event. The size, location, and number of the inset images 64 may be changed by the viewer through simple manipulation of parameters of a program executed by CPU 38 input from the user's remote control 29.

Referring again to FIG. 2, the CPU 38 receives the video and audio data broadcast from the web servers 56 and sums it to the data received from the cable 30 as broadcast data using booster amplifier 42 which gives priority to the signal generated by CPU 38 when that signal is present creating the overlapping image of inset images 64. The program executed by the CPU 38 is a standard video reception program of a type well known in the art providing for resizing and activation and deactivation of particular video streams from the web servers 56.

Several different audio modes may be provided by the converter interface 26. In a first mode, audio from the viewers 20 preempts the audio from the broadcast program. In a second mode, audio from the viewers 20 is summed together with the audio from the broadcast program. The volumes of the Internet broadcast audio can be adjusted independently of each other and of the volume of the broadcast program.

The inset images 64 may be turned on and off by the viewer 20 or may switch automatically depending on audio signals associated with the particular inset image 64, so for example, to switch to a speaking viewer 20.

The programming of the CPU 38 for implementation of the virtual community terminal 10 may be done by downloading of information from the web servers 56 provided by the cable company 53 (to allow the service to be easily installed and de-installed) and programming of different user parameters can be done interactively by the viewer 20 through a standard computer (not shown) connected to the Internet 62 or a keyboard or remote control communicating directly to the CPU 38 by the infrared beam 40.

A particular advantage of the present invention is that it does not require a separate license to rebroadcast the sporting event in stream form over the Internet. However the present invention contemplates in one embodiment that such streaming may occur.

The term Internet and Internet protocol signals as used in the specification and claims is intended to cover a network exchanging digital data arranged in addressed data packets, as on the Internet, whether or not the network is publicly accessible or the particular protocol of TC/IP is used.

It is specifically intended that the present invention not be limited to the embodiments and illustrations contained herein, but include modified forms of those embodiments including portions of the embodiments and combinations of elements of different embodiments as come within the scope of the following claims.

1. A virtual community television system comprising:
a display monitor;
a first tuner system for receiving a broadcast video program and displaying it on the display monitor;
a second tuner system for receiving an Internet protocol digital signal to display a video signal of a remote viewer of the broadcast video program on the monitor;
a camera providing a video signal of a person watching the display monitor; and
a distribution amplifier system transmitting the video signal from the camera as an Internet protocol digital signal to the remote viewer.

2. The virtual community television system of claim 1 wherein the first tuner is a cable television tuner.

3. The virtual community television system of claim 2 wherein the second tuner is a cable modem.

4. The virtual community television system of claim 1 wherein the first tuner is a television tuner receiving a free-space radio broadcast.

5. The virtual community television system of claim 1 wherein the display of the video signal of the remote viewer is an inset in the display of the broadcast video program.

6. The virtual community television system of claim 1 wherein the first tuner includes a remote control for changing a channel of the broadcast video program independently of the reception of the Internet protocol digital signal.

7. The virtual community television system of claim 1 further including a microphone providing an audio signal of the person watching the display monitor; and wherein the distribution amplifier system transmits the audio signal to the remote viewer.

8. The virtual community television system of claim 7 wherein the broadcast video program and video signal of the remote viewer include audio tracks and including a summer summing the audio tracks to output to a viewer.

9. The virtual community television system of claim 7 wherein the broadcast video program and video signal of the remote viewer include audio tracks and including a summer selecting a louder of the audio tracks for output to a viewer.

10. A virtual community television system comprising:
a television display screen;
a cable television tuner system for receiving a broadcast video program from a cable distribution system in a first frequency band and displaying it on the television display screen;
a cable modem for receiving an Internet protocol digital signal from the cable distribution system in a second frequency band and displaying a video signal of a remote viewer of the broadcast video program on the television display screen;
a camera providing a video signal of a person watching the television display screen; and
a distribution amplifier system transmitting the video signal from the camera as an Internet protocol digital signal over the cable distribution system in a third frequency band to the remote viewer.

11. A virtual community cable service comprising:
a server communicating with a subscriber network providing a plurality of connected terminal devices providing display monitors and cameras providing images of viewers of the display monitors, the server programmed to:
(1) broadcast a video program to the connected terminal devices;
(2) exchange Internet protocol signals with the connected terminal devices; and
(3) interconnect a subset of the connected terminal devices receiving the broadcast video program to each other to exchange images of viewers of the respective display monitors of the subset of connected terminal devices.

12. The virtual community cable service of claim 11 wherein the subset is defined by a community table cross referencing a set of Internet addresses of users of the connected terminal devices.

13. The virtual community cable service of claim 12 may accept Internet protocol signals from connected terminal devices to populate the community table.

14. The virtual community cable service of claim 12 wherein each connected terminal device, when receiving a broadcast, provides a Internet protocol signal to the server when activated to initiate the interconnection of other connected terminal devices receiving the broadcast and associated with the connected terminal devices by the community table.
